(19) United States
(12) Patent Application Publication
(10) Pub. No.: US 2009/0168856 A1
(43) Pub. Date: Jul. 2, 2009

(54) System and Method for Adaptive Equalization of In-Package Signals

(76) Inventor: Khurram Muhammad, Dallas, TX (US)

Correspondence Address: TEXAS INSTRUMENTS INCORPORATED, P O BOX 655474, M/S 3999, DALLAS, TX, 75265, US

(21) Appl. No.: 12/029,743

(22) Filed: Feb. 12, 2008

Related U.S. Application Data
(63) Continuation of application No. 61/017,374, filed on Dec. 28, 2007.

(51) Int. Cl. H04B 1/38; H04L 5/16

(52) U.S. Cl. 375/221; 375/232

(57) ABSTRACT

A system and method for adaptive equalization of in-package signals. A method for operating a wireless communications device having a transmitter and a receiver includes receiving a transmitted signal at the receiver, wherein the receiving of the transmitted signal occurs by mutual inductance, converting the received transmitted signal into a baseband signal, equalizing the baseband signal, computing a correction signal from the equalized baseband signal, and providing the correction signal to the transmitter. The equalizing of the baseband signal helps to eliminate or reduce multipath arising from mutual inductance between the transmitter and the receiver. The elimination of the multipath helps to improve the quality of the correction signal, thereby helping to increase the performance of the wireless communications device.

This application claims the benefit of U.S. Provisional Application No. 61/017,374, filed on Dec. 28, 2007, entitled “System and Method for Adaptive Equalization of In-Package Signals,” which application is hereby incorporated herein by reference.

### TECHNICAL FIELD

The present invention relates generally to a system and method for wireless communications, and more particularly to a system and method for adaptive equalization of in-package signals.

### BACKGROUND

In a wireless communications device operating in full-duplex mode or in half-duplex mode with a receiver operating in an on state, when a transmitter of the wireless communications device transmits a signal, a receiver of the wireless communications device will also likely receive the signal. The signal, as received by the receiver, may be referred to as a blocker signal. Since the transmitter and the receiver of the wireless communications device are typically located in close proximity, the blocker signal may have a high power level. Due to its potentially high power level, the blocker signal may then become a signal block for the reception of other transmitted signals. This problem may be exacerbated when the transmitter and the receiver of the wireless communications device are co-located in a single integrated circuit.

With reference now to FIG. 1, there is shown a diagram illustrating a portion of a wireless communications device 100. The wireless communications device 100 includes a transmitter 105 and a receiver 110. The wireless communications device 100 may transmit data provided by a baseband unit over the air through an antenna 115. While the receiver 110 of the wireless communications device 100 may receive transmissions over the air, also through the antenna 115. A duplexer 120, coupled in between the antenna 115 and the transmitter 105 and the receiver 110, may allow for the sharing of the antenna 115 by both the transmitter 105 and the receiver 110.

A transmission made by the transmitter 105 (shown as dashed line 125) may be received by the receiver 110 (shown as dashed/dotted line 130) in the form of a blocker signal. FIG. 2a illustrates a diagram of a time versus signal magnitude data plot for a portion of a transmitted signal 205. FIG. 2b illustrates a diagram of a time versus signal magnitude data plot of a portion of a received signal 225 (solid lines) and a portion of a blocker signal 230 (dashed lines). Since the receiver 110 and the transmitter 105 are closely located, the power level of the blocker signal 230 may exceed the power level of the received signal 225. The signals displayed in FIGS. 2a and 2b are for illustrative purposes and may not be representative of an actual received signal.

However, the receiver 110 may also receive the transmitter's 105 transmissions through means other than the antenna 115. The receiver 110 may also receive transmissions from the transmitter 105 through mutual inductance. Mutual inductance occurs when conductive signal traces are in close proximity and a signal carried on a first conductive signal trace induces a copy of the signal on a second conductive signal trace. Mutual inductance may also be referred to as parasitic coupling. Referring back to FIG. 1, mutual inductance may occur between conductive signal traces taking the signal from transmitter 105 to the duplexer 120 and conductive signal traces taking signals from the duplexer 120 to the receiver 110, as well as at other locations where conductive signal traces are in close proximity. This is shown in FIG. 1 as dotted line 135.

Mutual inductance may result in multiple copies of the transmitted signal at a signal input of the receiver 110, resulting in a multi-path like effect. The multi-path effect may result in significant inter-symbol interference (ISI), which may seriously degrade the performance of the wireless communications device 100. The multi-path effect may not be readily corrected through the use of filters.

### SUMMARY OF THE INVENTION

These and other problems are generally solved or circumvented, and technical advantages are generally achieved, by embodiments of a system and a method for adaptive equalization of in-package signals.

In accordance with an embodiment, a method for operating a wireless communications device having a transmitter and a receiver is provided. The method includes receiving a transmitted signal at the receiver, converting the received transmitted signal into a baseband signal, and equalizing the baseband signal. The method also includes computing a correction signal from the equalized baseband signal, and providing the correction signal to the transmitter. The receiving of the transmitted signal occurs by mutual inductance of a transmission of the transmitted signal made by the transmitter.

In accordance with another embodiment, a transceiver is provided. The transceiver includes a transmitter coupled to a signal input, the transmitter generates and transmits radio frequency (RF) signals from data provided by the signal input, a receiver co-located with the transmitter and coupled to the transmitter, and an equalizer coupled to the receiver and to the transmitter. The receiver receives RF signals transmitted by the transmitter by mutual inductance and over the air by an antenna, and the equalizer reduces multipath present in a signal transmitted by the transmitter and received at the receiver and to provide a correction signal to the transmitter.

In accordance with another embodiment, a wireless communications device is provided. The wireless communications device includes a radio integrated circuit to transmit radio frequency (RF) signals over the air and to receive RF signals over the air, a power amplifier coupled to the radio integrated circuit, and a diplexer coupled to the power amplifier. The radio integrated circuit includes a transmitter coupled to a signal input, the transmitter transmits RF signals from the signal input, a receiver coupled to the transmitter, the receiver receives RF signals transmitted by the transmitter by mutual inductance and over the air by an antenna, and an equalizer coupled to the receiver and to the transmitter. The equalizer reduces multipath present in a signal transmitted by the transmitter and received at the receiver. The power amplifier brings a signal level of an RF signal to a level suitable for over the air transmission, and the diplexer enables a sharing of the antenna by the transmitter and the receiver.

An advantage of an embodiment is that on-chip signal processing is used to train an equalizer that may be used to linearize a transmitter's output. The use of on-chip signal processing may involve digital and software techniques that may enable future changes to meet evolving needs without a redesign of the transmitter, equalizer, and/or training hardware.

A further advantage of an embodiment is that the training of the equalizer may be achieved through the use of mutual inductance and radio frequency signals. The use of radio frequency signals may allow for better training of the equalizer, yielding better linearization results.

Yet another advantage of an embodiment is that the use of on-chip signal processing may allow for a more efficient (in terms of power consumption and area usage). This may yield a design that is smaller overall and uses less power.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 is a diagram of a portion of a wireless communications device;

FIG. 2a is a diagram of a time versus signal magnitude data plot illustrating a portion of a transmitted signal;

FIG. 2b is a diagram of a time versus signal magnitude data plot illustrating a portion of a received signal and a portion of a blocker signal;

FIG. 3a is a diagram of a wireless communications device;

FIG. 3b is a diagram of a wireless communications device;

FIG. 4 is a time versus signal magnitude data plot illustrating multipath arising from mutual inductance in a portion of a received signal;

FIG. 5a is a diagram of a wireless communications device having an equalizer;

FIG. 5b is a diagram of a wireless communications device having an equalizer;

FIG. 6 is a flow diagram of a sequence of events in training an equalizer;

FIG. 7 is a flow diagram of a sequence of events in using an equalizer to linearize an output of a transmitter; and

FIG. 8 is a flow diagram of a sequence of events in using an equalizer to produce a cancellation signal.

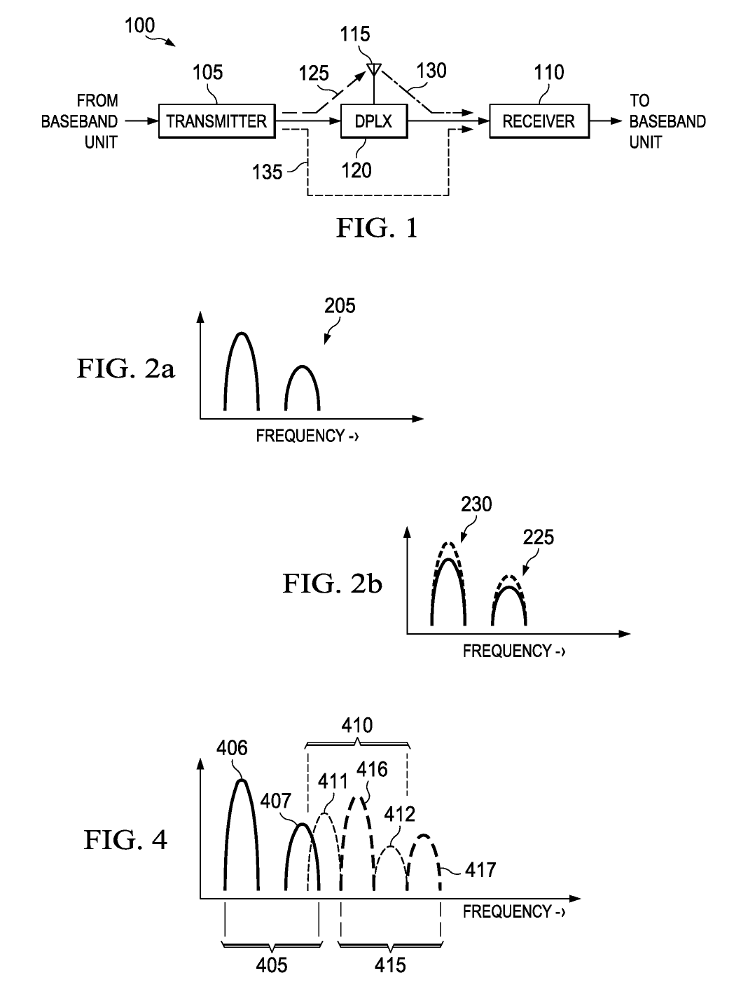

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a wireless communications device having an integrated radio frequency circuit, the radio frequency circuit containing a transmitter and a receiver. The invention may also be applied, however, to other wireless transceivers used in a wide variety of wireless communications, such as wireless data communications, wireless multimedia communications, and so forth, wherein the transmitter and the receiver of the wireless transceivers are in close proximity to one another and may negatively impact each other's performance.

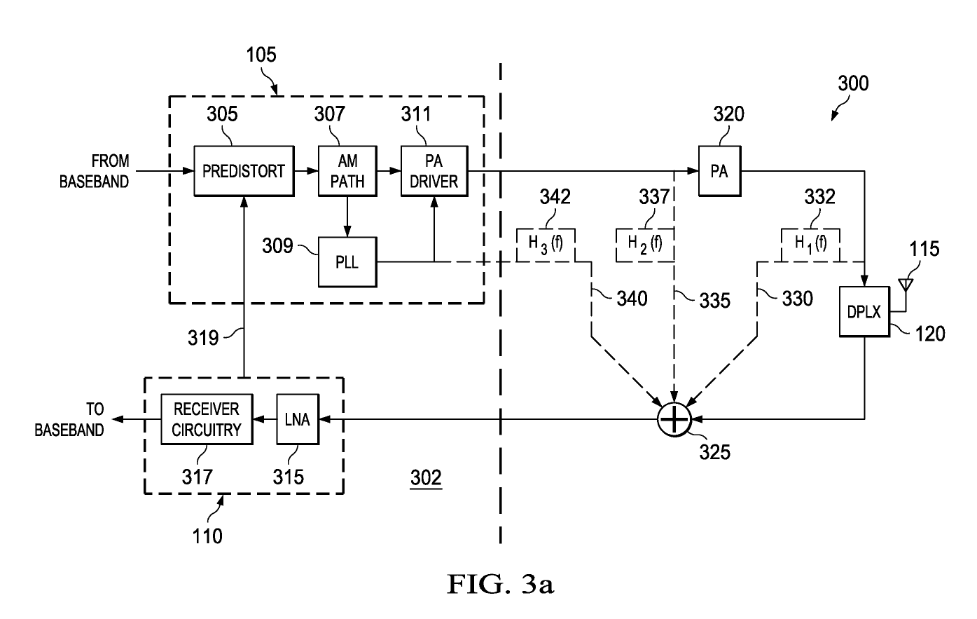

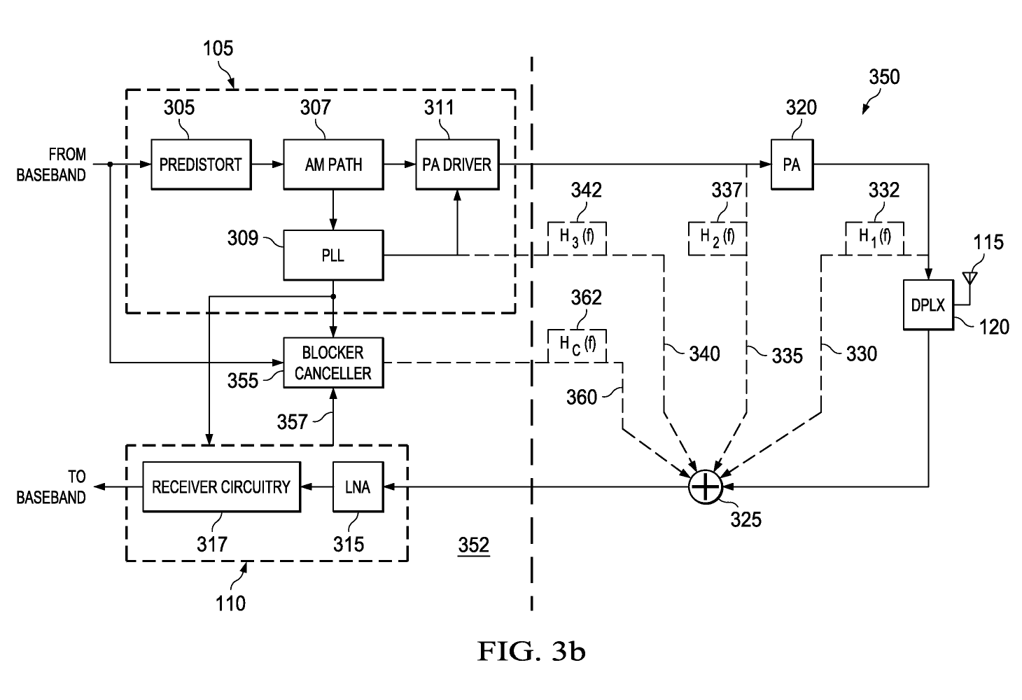

FIG. 3a is a diagram of a wireless communications device 300, showing potential sources of mutual inductance. The wireless communications device 300 includes an RF integrated circuit 302 containing a transmitter 105 and a receiver 110. The wireless communications device 300 also includes a power amplifier (PA) 320 that may be used to amplify a signal to be transmitted over the air via the antenna 115 to desired power levels. The duplexer 120 may be used to allow sharing of the antenna 115 by both the transmitter 105 and the receiver 110.

The transmitter 105 includes a predistort unit 305, an amplitude modulation (AM) signal path 307, a phase-locked loop (PLL) 309, and a preamplifier (PA) driver 311. The predistort unit 305 may be used to help ensure that the output of the PA 320 remains linear to meet performance requirements. The predistort unit 305 may distort a signal from a baseband unit prior to signal processing to help ensure an overall linearity at the output of the PA 320. The AM signal path 307 includes circuitry responsible for processing of the signal to be transmitted, such as interpolation filters, modulators, upconverters, and so forth. The PLL 309 may be used to generate a local oscillator reference signal (a reference clock signal) and the PA driver 311 may be used to amplify the signal by an amount specified by an amplifier control word. Although the transmitter 105 shown in FIG. 3a is a polar transmitter, the present invention may also be applicable with Cartesian transmitters. Therefore, the discussion of polar transmitters should not be construed as being limiting to either the scope or the spirit of the embodiments.

The receiver 110 includes a low noise amplifier (LNA) 315 that may be used to amplify signals received by the antenna 115 to power levels compatible with receiver circuitry 317. Examples of circuitry contained within the receiver circuitry 317 may include a transconductance amplifier, baseband filters, analog-to-digital converters, script processors, and so forth. The receiver 110 may also provide to the transmitter 105 an error signal on signal line 319 that is based on transmissions made by the transmitter 105 and received at the receiver 110. The error signal may be used by the predistort unit 305 of the transmitter 105 to predistort signals provided by the baseband unit so that the output of the PA driver 311 and/or the PA 320 are linear. Effectively, the signal line 319 creates a closed loop linearization system for wireless communications device 300 for use in linearizing the PA driver 311, the PA 320, or both.

A summing point 325 may represent a signal input to the receiver 110. As discussed previously, the receiver 110 may receive signals not only from the antenna 115, but from the transmitter 105 by mutual inductance. Sources of mutual inductance may include the duplexer 120 (shown as dotted line 330), output of the PA driver 311 (shown as dotted line 335), as well as output of the PLL 309 (shown as dotted line 340). In general, mutual inductance may occur when a conductive signal trace in the transmitter 105 in close proximity to a conductive trace in the receiver 110 conveys a signal at a sufficient power level. The signal may then appear on the conductive trace in the receiver 110. The sufficient power level may be a function of how close the conductive signal trace in the transmitter 105 is to the conductive trace in the receiver 110.

The transfer of signals by mutual inductance between a conductive signal trace in the transmitter 105 and the conductive trace in the receiver 110 may be described using a transfer function, H(f), with the transfer functions being: H₁(f) 332 for the duplexer 120 to receiver 110, H₂(f) 337 for the PA driver 311 to receiver 110, and H₃(f) 342 for the PLL 309 to receiver 110. Therefore, the signal at the input to the receiver 110, due to mutual inductance, may be expressed as a sum of the signal transmitted by the transmitter 105 (the transmitted signal) multiplied by the transfer functions, or

$${input}_{MI} = [ transmitted signal @ duplexer 120 ] * {H}_{1} ( f ) 332 + \\ [ transmitted signal @ PA driver 311 ] * {H}_{2} ( f ) 337 + \\ [ transmitted signal @ PLL 309 ] * {H}_{3} ( f ) 342.$$

FIG. 3b is a diagram of a wireless communications device 350, showing potential sources of mutual inductance. The wireless communications device 350 may be similar to the wireless communications device 300 in that an RF integrated circuit 352 includes a transmitter 105 and a receiver 110. The RF integrated circuit 352 also includes a blocker canceller 355 that may be used to help eliminate a blocker signal at the receiver 110 due to a signal transmission made at the transmitter 105 and received at the receiver 110 by way of the antenna 115. A signal line 357 may provide the blocker canceller 355 with information related to the receiver's reception of the signal transmission made by the transmitter 105. The blocker canceller 355 may be a secondary transmitter located in the RF integrated circuit 352.

The blocker canceller 355 may generate a version of the blocker signal that is about 180 degrees out-of-phase with respect to the blocker signal, referred to as a cancellation signal. The cancellation signal may be combined with signals at the receiver 110 to eliminate the blocker signal. The cancellation signal may appear at the receiver 110 through mutual inductance.

FIG. 3c is a detailed view of the blocker canceller 355. The blocker canceller 355 includes an adaptive filter 370 and an adaptive algorithm unit 375. The adaptive algorithm unit 375 implements an algorithm, such as a least means squared (LMS) algorithm, means squared error (MSE), method of steepest descent (MSD), or so forth, using transmitted data information from a baseband processor and an error signal (potentially computed from the receiver's reception of the signal transmission made by the transmitter 105) to control the operation and to configure the adaptive filter 370 to generate the cancellation signal. A detailed description of the blocker canceller 355 may be found in co-assigned patent application entitled “RF Transmission Leakage Mitigator, Method of Mitigating an RF Transmission Leakage and CDMA Transceiver Employing the Same,” Ser. No. 11/270,121, filed Nov. 9, 2005, publication number 2007-0105509 A1, which patent application is hereby incorporated herein by reference. A detailed description of various adaptive algorithms that may be implemented in the adaptive algorithm unit 375 may be found in pages 19-26 of “Active Noise Control Systems: Algorithms and DSP Implementation (Wiley Series in Telecommunications and Signal Processing),” by Sen M. Kuo and Dennis R. Morgan, published 1996, by John Wiley & Sons, New York, N.Y., which are herein incorporated hereby reference.

Turning back to FIG. 3b, the blocker canceller 355 may provide another source of mutual inductance, shown as dotted line 360 with a transfer function H_{C}(f) 362. Therefore, a signal at the input to the receiver 110, due to mutual inductance, may be expressed as a sum of the transfer functions times the signal transmitted by the transmitter 105, or

$${input}_{MI} = [ transmitted signal @ duplexer 120 ] * {H}_{1} ( f ) 332 + [ transmitted signal @ PA driver 311 ] * {H}_{2} ( f ) 337 + [ transmitted signal @ PLL 309 ] * \\ {H}_{3} ( f ) 342 + [ transmitted signal @ bl ock canceller 355 ] * {H}_{C} ( f ) 362.$$

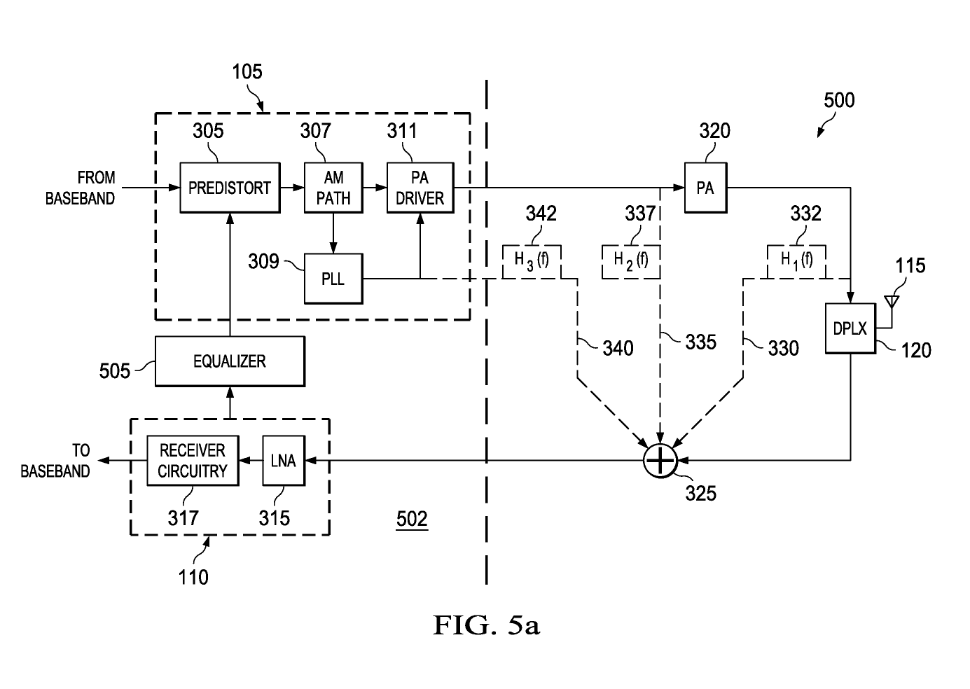

FIG. 4 is a diagram of a time versus signal magnitude data plot of a portion of a signal at the input of the receiver 110. As shown in FIG. 4, the signal at the input of the receiver 110 comprises three separate signals. A first signal 405 includes pulses 406 and 407, a second signal 410 includes pulses 411 and 412, and a third signal 415 includes pulses 416 and 417. The signals making up the signal at the input of the receiver 110 may have been transmitted by the transmitter 105 and, through mutual inductance, appeared at the input of the receiver 110. For example, the first signal 405 may be the result of mutual inductance with the duplexer 120, the second signal 410 may be the result of mutual inductance with the PA driver 311, while the third signal 415 may be the result of mutual inductance with the PLL 309. Each of the signals may have differences in magnitude, phase, and so forth, due to differences in the respective transfer functions. The signals displayed in FIG. 4 are for illustrative purposes and may not be representative of an actual received signal.

The signal at the input of the receiver 110 may be considered to be a sum of multiple copies of the signal transmitted by the transmitter 105, with each copy of the transmitted signal appearing at the input to the receiver 110 potentially being different. For example, the copies may have different magnitudes, phase properties, and so forth. Furthermore, the copies may be distorted in different ways due to differences in electrical properties of the electrical component from which they originate, for example, the duplexer 120, the PA driver 311, the PLL 309, may each distort the transmitted signal differently. Additionally, the copies may appear at the input to the receiver 110 at different times, due to differences in propagation delay, for example.

The signal at the input to the receiver 110, due to mutual inductance, may be analogous to multipath in a wireless communications system. In a wireless communications system, a transmitted signal may travel multiple paths between a transmitter and a receiver. For example, the transmitted signal may travel a direct path between the transmitter and the receiver. However, the receiver may also receive copies of the transmitted signal after the transmitted signal has reflected off buildings, mountains, large objects, such as busses, trucks, and so forth. Since a reflected transmitted signal generally propagates over a longer distance than a transmitted signal traveling a direct path, the copies of the transmitted signal may arrive at the receiver at different times with the signal traveling a direct path generally arriving first. Furthermore, the reflections as well as the path traversed by the transmitted signals may distort, attenuate, and other wise alter the transmitted signal, therefore, the copies of the transmitted signal may each be different.

The multipath properties of the signal at the input to the receiver 110, due to mutual inductance, may make it difficult for the receiver 110 to extract the transmitted signal from the signal at the input of the receiver 110. Therefore, the receiver 110 may have difficulty generating the error signal to provide to the predistort unit 305 of the transmitter 105 to linearize the output of the PA driver 311, the PA 320, or both, as shown in FIG. 3a. Similarly, the multipath properties of the signal at the input to the receiver 110 may also make it difficult for the receiver 110 to provide the blocker canceller 355 with the blocker signal so that the blocker canceller 355 may generate the cancellation signal that is about 180 degrees out-of-phase with respect to the blocker signal, as shown in FIG. 3b.

To reduce or eliminate the impact of multipath in a wireless communications device operating in a wireless communications system, an equalizer may be used. The equalizer may adjust signal magnitudes of some or all of the different copies of the transmitted signal, delay some or all of the copies, and then combine them into a single copy of the transmitted signal. In order to effectively reduce or eliminate multipath, the equalizer must be trained, often using a known training sequence. The training of the equalizer may be used to adjust coefficients of the equalizer, for example, so that a signal received at the receiver 110 may be identical (or substantially identical within an acceptable tolerance level) in appearance to the known training sequence. Once trained, the equalizer may be used to reduce or eliminate the effect of multipath and ISI on signals received by the receiver 110. Since an operating environment of the wireless communications system may typically be dynamic (for example, a user of the wireless communications device may be moving), the training of the equalizer may need to be repeated periodically to maintain the effectiveness of the equalizer. The use of an equalizer in a wireless communications device is considered to be well known by those of ordinary skill in the art and will not be discussed further herein.

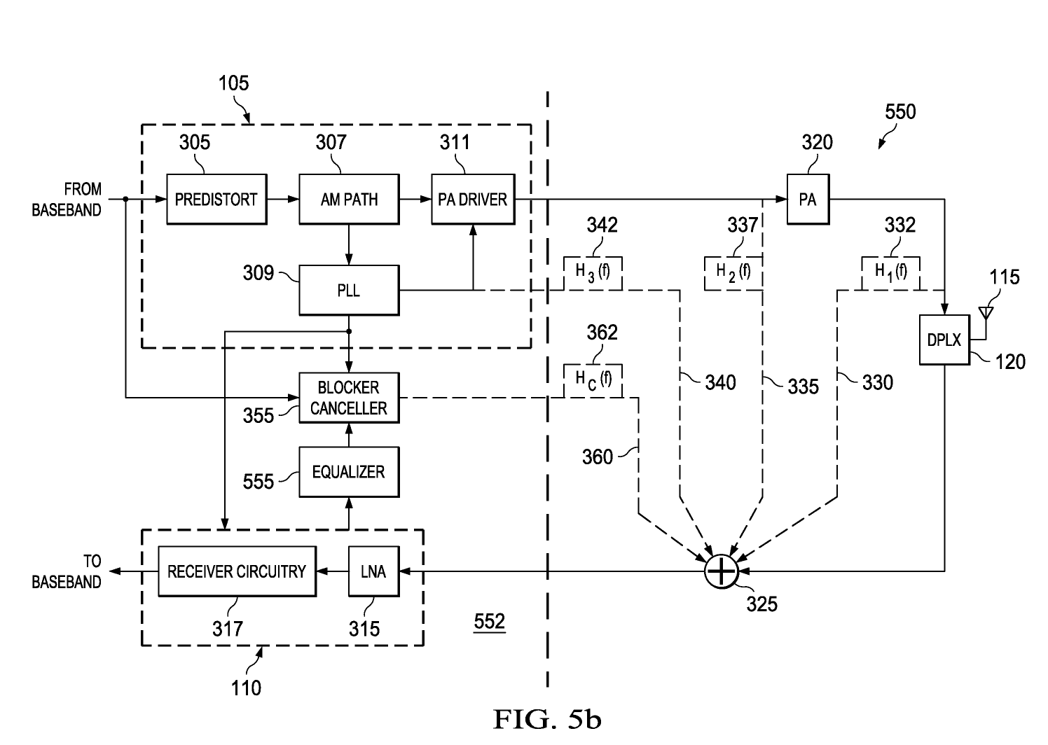

Since the signal at the input to the receiver 110 due to mutual inductance may have many of the properties and characteristics of a multipath signal, an equalizer may be used to help reduce or eliminate the multipath properties of the signal at the input to the receiver due to mutual inductance. FIG. 5a is a diagram of a wireless communications device 500. The wireless communications device 500, as shown in FIG. 5a, may be similar to the wireless communications device 300 with the addition of an equalizer 505 coupled between the receiver 110 and the transmitter 105. The equalizer 505, as well as the transmitter 105 and the receiver 110, may be located on an RF integrated circuit 502. The equalizer 505 includes an input coupled to the receiver 110 that may receive a version of a signal at the input to the receiver 110, such as the signal at the input of the receiver 110 that is due to mutual inductance. The signal may have received processing, such as amplification, filtration, demodulation, digitization, and so forth, prior to being provided to the equalizer 505. The equalizer 505 may be implemented using infinite impulse response (IIR) filters, finite impulse response (FIR) filters, or combinations thereof.

The equalizer 505 may be trained using a known training sequence. While being trained, coefficients of the equalizer 505 may be adjusted so that the equalizer 505 is capable of producing an error signal that is based on the training sequence and an equalized, received version of the training sequence. Ideally, with the equalizer 505 properly trained, the error signal should be substantially equal to zero. The feedback error signal may be provided to the predistort unit 305 of the transmitter 105, which may then make adjustments necessary to linearize the output of the PA driver 311, the PA 320, or both. The adjusting of the coefficients of the equalizer 505 may be achieved using algorithms such as a means square adaptive algorithm or a least means square adaptive algorithm. Such adaptive algorithms are considered to be well understood by those of ordinary skill in the art and will not be discussed further herein.

In general, the multipath properties of the signal at the input of the receiver 110 due to mutual inductance may not change significantly over time. Small changes in mutual inductance may occur due to changes in operating temperature of the wireless communications device 500. However, since the relative positions of the sources of mutual inductance and the receiver 110 does not change the multipath properties of the signal at the input of the receiver 110 may not change dramatically in normal use. Therefore, the training of the equalizer 505 may occur infrequently. For example, the equalizer 505 may be trained during the manufacture of the wireless communications device 500 and the coefficients of the equalizer 505 may be stored in a memory for later use. Alternatively, the equalizer 505 may be trained during an initial configuration with a wireless service provider. Also, the equalizer may be trained each time that the wireless communications device 500 is powered on. If the wireless communications device 500 remains powered on for an extended period of time, then the equalizer 505 may be trained once everyday, every few days, weeks, or so forth. Furthermore, if in consecutive equalizer trainings, the coefficients of the equalizer 505 do not change significantly, the period of time between equalizer trainings may be extended.

FIG. 5b is a diagram of a wireless communications device 550. The wireless communications device 550, as shown in FIG. 5b, may be similar to the wireless communications device 350 with the addition of an equalizer 555 coupled between the receiver 110 and the blocker canceller 355. The equalizer 555, as well as the transmitter 105 and the receiver 110, may be located on an RF integrated circuit 552. The equalizer 555 includes an input coupled to the receiver 110 that may receive a version of a signal at the input to the receiver 110, such as the signal at the input of the receiver 110 that is due to mutual inductance. The signal may have received processing, such as amplification, filtration, demodulation, digitization, and so forth, prior to being provided to the equalizer 555. As with the equalizer 505, the equalizer 555 may be implemented using infinite impulse response (IIR) filters, finite impulse response (FIR) filters, or combinations thereof.

After training, the equalizer 555 may provide to the blocker canceller 355 a blocker signal without any (or a significant amount of) multipath behavior arising from mutual inductance between various components in the transmitter 105 and the receiver 110. In other words, the equalizer 555 may provide to the blocker canceller 355 the blocker signal. The blocker canceller 355 may make use of the blocker signal as received by the receiver 110 with multipath eliminated or substantially eliminated to create the cancellation signal to help eliminate the blocker signal.

FIG. 5c is a detailed view of the blocker canceller 355 and the equalizer 555. Functionally, the blocker canceller 355 and the equalizer 555 may be similar, with each including an adaptive filter and an adaptive algorithm unit. The blocker canceller 355 includes the adaptive filter 370 and the adaptive algorithm unit 375, while the equalizer 555 includes an adaptive filter 5 80 and an adaptive algorithm unit 5 85. The adaptive algorithm unit 5 85 implements an algorithm, such as a least means squared (LMS) algorithm, means squared (MS), or so forth, using a training sequence and an error signal (potentially computed from the receiver's reception of the signal transmission made by the transmitter 105) to train coefficients of the adaptive filter 580. Trained, the adaptive filter 580 may eliminate (or reduce) multipath properties of the error signal, producing an equalized error signal. The equalized error signal may then be provided to the blocker canceller 355 where it may be used to generate the cancellation signal.

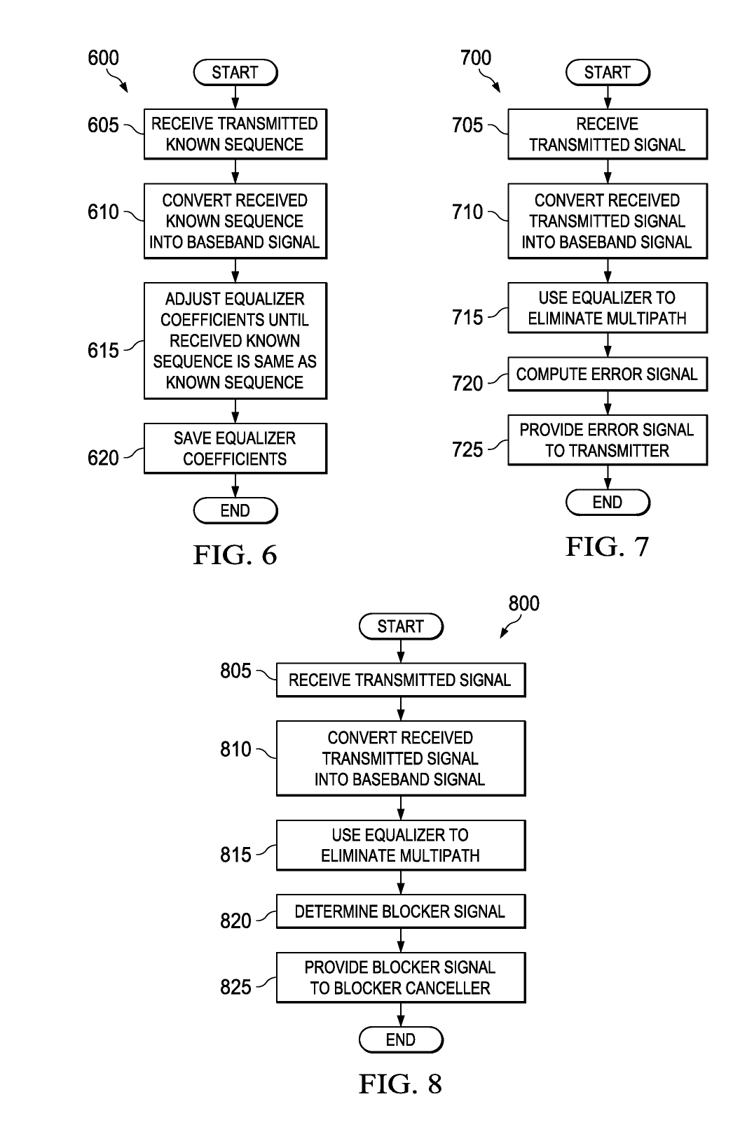

FIG. 6 is a diagram of a sequence of events 600 in the training of an equalizer in a wireless communications device. As discussed previously, prior to being able to effectively eliminate (or reduce) multipath, the equalizer 505 or 555 may need to be trained. The training may occur during manufacture of a wireless communications device, such as the wireless communications device 500 or 550, containing the equalizer 505 or 555. Alternatively, the training of the equalizer 505 or 555 may occur during power-on or use.

The equalizer training may begin with the receiver 110 receiving a transmission of a known sequence (block 605). The receiver 110 may receive the transmission of the known sequence from the transmitter 105 by mutual inductance from sources of mutual inductance such as the duplexer 120, the PLL 309, the PA driver 311, the blocker canceller 355, and so forth. After receiving the transmission of the known sequence from the transmitter 105, the received transmission may be provided to receiver circuitry contained in the receiver 110 that may convert the received transmission into a baseband signal (block 610). The conversion into a baseband signal may involve operations such as filtering, demodulating, downconverting, and so forth. The baseband signal may then be provided to the equalizer 505 or 555 (block 615).

Since the transmission is of a known sequence, the equalizer 505 or 555 knows the expected appearance of the baseband signal. The equalizer 505 or 555 may adjust its equalizer coefficients until the baseband signal has the appearance of the known sequence. The equalizer 505 or 555 may adjust the equalizer coefficients until the baseband signal is within some threshold of having the appearance of the known sequence. The value of the threshold may depend on the desired equalizer performance as well as available equalizer processing capability. After the equalizer 505 or 555 has adjusted its equalizer coefficients to its satisfaction, the equalizer coefficients may be saved for subsequent use (block 620). The equalizer coefficients may be stored in a memory specially dedicated for the equalizer coefficients or the memory may be a general purpose memory that may be used for storage by other circuits in the wireless communications device 500 or 550.

FIG. 7 is a diagram of a sequence of events 700 in the use of an equalizer in a wireless communications device to linearize transmitter output. A commonly used technique to improve the performance of a wireless communications device is to distort a baseband signal prior to processing for transmission purposes so that compensation for an amplifier's non-linearity is provided. By altering the baseband signal's magnitude and phase characteristics, a linear output at the wireless communications device's PA driver 311, PA 320, or both may be achieved. The technique is commonly referred to as predistortion.

Predistortion may require an accurate characterization of the performance of the wireless communications device's PA driver 311, PA 320, or both. Therefore, if there is significant multipath in the signal at the input of the receiver 110, it may not be possible to obtain good performance through predistortion. The use of an equalizer may help the predistortion performance through the elimination or reduction of multipath, which may provide a better characterization of the performance of the wireless communications device's PA driver 311, PA 320, or both.

The linearization of the transmitter's output may begin with the receiver 110 receiving a transmitted signal that has been transmitted by the transmitter 105 (block 705). The transmitted signal as received by the receiver 110 may then be converted into a baseband signal by circuitry in the receiver 110 (block 710). The conversion into a baseband signal may include demodulation, downconversion, filtering, conversion into a digital signal, and so forth. Due to mutual inductance, the transmitted signal as received by the receiver 110 (as well as its associated baseband signal) may be likely to have multipath characteristics. The wireless communications device's equalizer 505 may be used to eliminate or reduce the multipath characteristics (block 715). In general, the equalizer 505 or 555 may eliminate or reduce the multipath in the baseband signal by altering the gain of each of the copies of the transmitted signal as well as adjusting a delay for each copy and then combining them into a single copy of the baseband signal.

After the equalizer 505 or 555 has eliminated the multipath, an error signal may be computed (block 720). The error signal may be a difference between a frequency response of an expected output of the transmitter 105 and a frequency response of an actual output of the transmitter 105. For example, if within a first frequency range, the actual output of the transmitter 105 is lower than the expected output of the transmitter 105 by 2 dB, then, the error signal may convey a negative 2 dB difference in the first frequency range. Similarly, if within a second frequency range, the actual output of the transmitter 105 is higher than the expected output of the transmitter 105 by 1.5 dB, then, the error signal may convey a positive 1.5 dB difference in the first frequency range. The error signal may then be provided to the transmitter 105, where it may be used to adjust the predistortion performed by the predistortion unit 305 (block 725). For example, the predistortion unit 305 may increase the distortion of a signal to be transmitted within the first frequency range by 2 dB while it may decrease the distortion of the signal to be transmitted within the second frequency range by 1.5 dB.

FIG. 8 is a diagram of a sequence of events 800 in the use of an equalizer in a wireless communications device to eliminate a blocker signal. As discussed previously, in full duplex wireless communications devices, such as those operating in code division multiple access (CDMA) and wideband CDMA (WCDMA) communications systems, when the transmitter 105 transmits, the transmission may become a blocker signal for the receiver 110. The blocker signal may be utilized by the blocker canceller 355 of the wireless communications device 550 to create a cancellation signal that may cancel out the blocker signal.

The blocker canceller 355 may create the cancellation signal by creating a version of the blocker signal that is about 180 degrees out-of-phase with the blocker signal. Therefore, the blocker canceller 355 may require a blocker signal that is as close to the transmission made by the transmitter 105 as possible. However, the multipath effects may distort the blocker signal. The use of an equalizer may help the blocker cancellation performance through the elimination or reduction of multipath, which may provide a blocker signal that is a better representation of the transmission made by the transmitter 105.

The elimination of the blocker signal may begin with the receiver 110 receiving a transmitted signal that has been transmitted by the transmitter 105 (block 805). The transmitted signal as received by the receiver 110 may then be converted into a baseband signal by circuitry in the receiver 110 (block 810). Due to mutual inductance, the transmitted signal as received by the receiver 110 (as well as its associated baseband signal) may be likely to have multipath characteristics. The wireless communications device's equalizer 555 may be used to eliminate or reduce the multipath characteristics (block 815). In general, the equalizer 555 may eliminate or reduce the multipath in the baseband signal by altering the gain of each of the copies of the transmitted signal as well as adjusting a delay for each copy and then combining them into a single copy of the baseband signal.

After the equalizer 555 has eliminated the multipath, the blocker signal may be determined (block 820). The blocker signal may simply be the received transmission from the transmitter 105 with the multipath removed. The blocker signal may then be provided to the blocker canceller 355, which may then compute the cancellation signal (block 825).

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for operating a wireless communications device having a transmitter and a receiver, the method comprising:
receiving a transmitted signal at the receiver, wherein the receiving of the transmitted signal occurs by mutual inductance of a transmission of the transmitted signal made by the transmitter;
converting the received transmitted signal into a baseband signal;
equalizing the baseband signal;
computing a correction signal from the equalized baseband signal; and
providing the correction signal to the transmitter.

2. The method of claim 1, wherein the transmitter has multiple sources of mutual inductance, and wherein receiving the transmitted signal comprises receiving a copy of the transmitted signal from each source of mutual inductance.

3. The method of claim 2, wherein receiving the transmitted signal comprises receiving a signal that is a sum of the multiple copies of the transmitted signal.

4. The method of claim 2, wherein equalizing the baseband signal comprises:
adjusting a signal gain for copies of the transmitted signal;
adjusting a delay for copies of the transmitted signal; and
combining the gain adjusted and delay adjusted copies into a single copy of the transmitted signal.

5. The method of claim 4, wherein an adjustment value for the signal gain and the delay are different for each copy of the transmitted signal.

6. The method of claim 1, further comprising prior to the receiving, training an equalizer using a transmission of a known sequence.

7. The method of claim 6, wherein training the equalizer comprises:
receiving the transmission of the known sequence at the receiver, wherein the receiving of the transmitted signal occurs by mutual inductance;
adjusting coefficients of the equalizer so that the received transmission substantially matches the known sequence; and
storing the coefficients of the equalizer.

8. The method of claim 7, wherein adjusting the coefficients comprises adjusting the coefficients until the received transmission substantially matches the known sequence to within a threshold.

9. The method of claim 1, wherein computing the correction signal comprises computing a difference signal between a frequency response of the equalized baseband signal and an expected frequency response.

10. The method of claim 1, wherein computing the correction signal comprises determining a blocker signal from the equalized baseband signal.

11. The method of claim 10, wherein the transmitter is a secondary transmitter, secondary to a primary transmitter used to transmit signals external to the wireless communications device.

12. A transceiver comprising:
a transmitter coupled to a signal input, the transmitter configured to generate and transmit radio frequency (RF) signals from data provided by the signal input;
a receiver co-located with the transmitter and coupled to the transmitter, the receiver configured to receive RF signals transmitted by the transmitter by mutual inductance and over the air by an antenna; and
an equalizer coupled to the receiver and to the transmitter, the equalizer configured to reduce multipath present in a signal transmitted by the transmitter and received at the receiver and to provide a correction signal to the transmitter.

13. The transceiver of claim 12, wherein the receiver is selected from the group consisting of: an infinite impulse response filter, a finite impulse response filter, and combinations thereof.

14. The transceiver of claim 12, wherein the transmitter is a secondary transmitter of the transceiver, the secondary transmitter configured to produce a cancellation signal from the correction signal.

15. The transceiver of claim 14, wherein the cancellation signal is a version of the correction signal that is about 180 degrees out-of-phase with respect to the correction signal.

16. The transceiver of claim 12, wherein the correction signal is an error signal between a frequency response of the transmitted signal received at the receiver with reduced multipath and an expected frequency response.

17. The transceiver of claim 16, wherein the transmitter comprises a predistort unit coupled to the equalizer, the predistort unit configured to distort the data based on the error signal.

18. A wireless communications device comprising:
a radio integrated circuit to transmit radio frequency (RF) signals over the air and to receive RF signals over the air, the radio integrated circuit comprising
a transmitter coupled to a signal input, the transmitter configured to transmit RF signals from the signal input,
a receiver coupled to the transmitter, the receiver configured to receive RF signals transmitted by the transmitter by mutual inductance and over the air by an antenna, and
an equalizer coupled to the receiver and to the transmitter, the equalizer configured to reduce multipath present in a signal transmitted by the transmitter and received at the receiver;
a power amplifier coupled to the radio integrated circuit, the power amplifier to bring a signal level of an RF signal to a level suitable for over the air transmission; and
a diplexer coupled to the power amplifier, the diplexer to enable a sharing of the antenna by the transmitter and the receiver.

19. The wireless communications device of claim 18, wherein the receiver is a secondary receiver of the wireless communication device.

20. The wireless communications device of claim 19, wherein the radio integrated circuit further comprises a primary receiver coupled to the transmitter, the primary receiver configured to receive RF signals transmitted by the transmitter over the air by the antenna while the transmitter is transmitting.
